(19) United States
(12) Patent Application Publication
(10) Pub. No.: US 2009/0231609 A1
(43) Pub. Date: Sep. 17, 2009

(54) Smarter Printing

(76) Inventors: Jan Chipchase, Tokyo (JP); Raphael Grignani, Woodland Hills, CA (US)

Correspondence Address: HARRINGTON & SMITH, PC, 4 RESEARCH DRIVE, Suite 202, SHELTON, CT, 06484-6212, US

(21) Appl. No.: 11/921,204

(22) PCT Filed: Jun. 29, 2005
(86) PCT No.: PCT/IB2005/001850

§ 371 Date: Nov. 27, 2007

(51) Int. Cl. G06F 3/12

(52) U.S. Cl. 358/1.15

(57) ABSTRACT

A print log is provided that stores first print jobs that have been used for printing and that include first settings. A print queue is provided that stores second print jobs that have not been used for printing and that include second settings. First settings from a selected print job in the print log are used as corresponding second settings for anew print job. The new print job is placed in the print queue to be used in response to a printer corresponding to the new print job being available. Another method is disclosed that provides a print log storing print jobs that have been used for printing. A print queue stores print jobs to be used for printing. A new print job is formed from a selected print job in the print log. The new print job is placed in the print queue and is printed.

### TECHNICAL FIELD

This invention relates generally to printing from an apparatus and, more specifically, relates to viewing and interacting with what has and will be printed, regardless of whether a printer is available for use.

### BACKGROUND OF THE INVENTION

Users are carrying small mobile devices, referred to as “mobile terminals” herein, that are able to capture and store a large numbers of documents, such as image documents. Many users consider these mobile terminals an essential item to take with them when out and about—and consequently there is a lot of opportunity to take and share the documents. For instance, image documents tend to be shared quite readily. Variations of mobile terminals are suitable for editing documents such as letters, spreadsheets, and the like. Additionally, with mobile flexible displays and near-to-eye displays, there are more opportunities to do work such as document editing whilst mobile.

Commercial infrastructure to support image printing is also becoming popular. For example, in Japan photo-printing-kiosks are widely available at film processing shops and electronics stores. Personal mobile printers are also starting to appear ranging from pocket printers by FUJI to portable bubble jet printers from CANON.

However, the inventors have realized that printing from a mobile terminal is different than printing from a PC with a large monitor. As an example, a small screen makes it difficult to preview multiple image documents especially when taken from a large image collection. Therefore, users are more likely to print single prints or small batches of images. The cost of printing ‘incorrectly’ is higher when mobile compared to printing from the home or office. If the user is carrying a mobile printer, the user is less likely to carry spare paper and ink, so there is less of a tendency to ‘waste’ prints. Therefore, the ‘cost’ of getting a printed image the user likes is higher. Printing kiosks also have a relatively high cost per print.

Because of these costs, in situations where multiple copies of the same image need to be printed, the user is likely to print a ‘test image’, check the results and if no more tweaks are required, go through the process again to make more prints. It can be assumed that in most cases, the user wishes to be in proximity to the printer so that the user can verify the quality of the print job. As compared to non-mobile printing, there will typically be a longer delay between choosing the ‘print’ command and the actual printing, and there will be a higher volume of printed items. This delay means that the settings for a print job are important for good quality prints. These factors result in many items appearing in the print queue and time wasted repeating the printing process for two or more prints. Moreover, once a document is printed using settings that are the user decides are suitable, the entire process typically must be performed again when setting up another document to print.

Additionally, for most users, it is easier to remember to print a document when the document is ‘finished’ rather than, for example, remembering to print when arriving back at the office. As documents are edited and finished whilst mobile, the user should be able to set up the print job whilst mobile. However, the inventors have realized that setting up a print job when a printer is not available typically is not possible on mobile terminals.

It would therefore be desirable to provide techniques that allow for smarter printing on mobile terminals.

### BRIEF SUMMARY OF THE INVENTION

The present invention provides techniques that offer smarter printing for apparatus such as mobile terminals.

In an exemplary aspect of the invention, a method is disclosed that provides a print log adapted to store first print jobs that have been used for printing. Each of the first print jobs includes a plurality of first settings. A print queue is provided and is adapted to store second print jobs that have not been used for printing. Each of the second print jobs includes a plurality of second settings. One or more first settings from a selected print job in the print log are used as corresponding second settings for a new print job. The new print job is placed in the print queue to be used in response to a printer corresponding to the new print job being available.

In another exemplary embodiment, an apparatus comprises a print log adapted to store first print jobs that have been used for printing. Each of the first print jobs includes a plurality of first settings. The apparatus also comprises a print queue adapted to store second print jobs that have not been used for printing. Each of the second print jobs includes a plurality of second settings. The apparatus additionally comprises a print application that uses one or more first settings from a selected first print job as corresponding second settings for a new second print job and that places the new second print job in the print queue to be used for printing in response to a printer corresponding to the new print job being available.

In another exemplary embodiment, a signal bearing medium is disclosed that tangibly embodies a program of machine-readable instructions executable by circuitry to perform operations. The operations include providing a print log adapted to store first print jobs that have been used for printing, where each of the first print jobs has a plurality of first settings. The operations also include providing a print queue adapted to store second print jobs that have not been used for printing, where each of the second print jobs includes a plurality of second settings. The operations additionally include using first settings from a selected first print job as corresponding second settings for a new second print job and placing the new second print job in the print queue to be used for printing in response to a printer corresponding to the new print job being available.

In yet another exemplary embodiment, an apparatus comprises means for providing a print log adapted to store first print jobs that have been used for printing, where each of the first print jobs includes a plurality of first settings. The apparatus also includes means for providing a print queue adapted to store second print jobs that have not been used for printing. Each of the second print jobs includes a plurality of second settings. The apparatus further includes means for using first settings from a selected first print job as corresponding second settings for a new second print job, and includes means for placing the new second print job in the print queue to be used for printing in response to a printer corresponding to the new print job being available.

In another exemplary aspect of the invention, a method is disclosed that provides a print log adapted to store print jobs that have been used for printing. A print queue is provided that is adapted to store print jobs to be used for printing. A new print job is formed from a selected one of the print jobs in the print log. The new print job is placed in the print queue. Printing is performed using the new print job, where the printing occurs in response to a printer corresponding to the new print job being available.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of an exemplary wireless communication system;

FIG. 2 is a diagram of screens showing a print preview operation performed by a user using a print application;

FIG. 3 is a diagram of screens showing an operation of modifying settings for a print job, the modification performed by a user using a print application;

FIG. 4 is a diagram of a reprinting operation performed by a user using a print application;

FIG. 5 is a flowchart of an exemplary method performed by a print application; and

FIG. 6 is a flowchart of an exemplary method performed by a thread of a print application for certain operations of a print queue.

### DETAILED DESCRIPTION OF EXEMPLARY EMBODIMENTS

An exemplary embodiment of this invention enables the user to set up a printing process from a mobile terminal regardless of whether the printer is present. For instance, via a print queue, the user can preview what is to be printed, and settings for each print job such as page orientation can be changed. Moreover, print jobs in the print queue can be cancelled, suspended, or duplicated. Printed print jobs are stored in a print log that can be accessed to reprint items or to apply settings from a previously printed print job to a new print job. A previously printed print job is a print job that has been used in the past for printing a document to which the print job corresponds. An unprinted print job is a print job that has not been used to print a document to which the print job corresponds.

The mobile terminal can connect to a printer using a variety of methods such as Bluetooth, an infrared connection, wired or wireless Local Area Networks (LANs), a direct-to-printer connection, fast serial ports such as Universal Serial Bus (USB) ports, and the like. The mobile terminal can also connect through a cellular phone system to the printer, if desired. Since each printer has its own specification and settings, in an exemplary embodiment of the disclosed invention it is proposed to have a standard but competitive print application on the terminal. This standard print application will cover 90 percent (as an example) of user wishes since the print application can be seamlessly and safely integrated to any other applications on the mobile terminal. If specific needs arise, this standard print application can be enhanced with add-ons from printer manufacturers. These add-ons might be pushed to the mobile terminal either when the mobile terminal makes the initial connection with the printer or via General Radio Packet Service (GPRS) or through other suitable techniques. These add-ons can become new screens or options in the standard print application.

Whether or not the user is nearby a printer while setting up the print job, in an exemplary embodiment the user can be prompted just before the printing takes place. This process allows the user to eventually complete, modify, and pay for the print job. Also, the user can receive a notification as soon as his mobile terminal is in range of a suitable printer or network having a suitable printer. For example, user can define to print only at a “Kodak Picture Machine” or to print to his own printer at home via WLAN only (e.g., low cost, fast upload). Additionally, a user can sort the print log, e.g., to see which are the most popular printed images, and sort (e.g., manually arrange) the print queue to speed up certain images or documents.

For documents such as WORD or EXCEL, where it is common that several versions exist of the same file or for documents that were edited after a test print, the user can specify to print the most recent available version of the file when interacting with the print log.

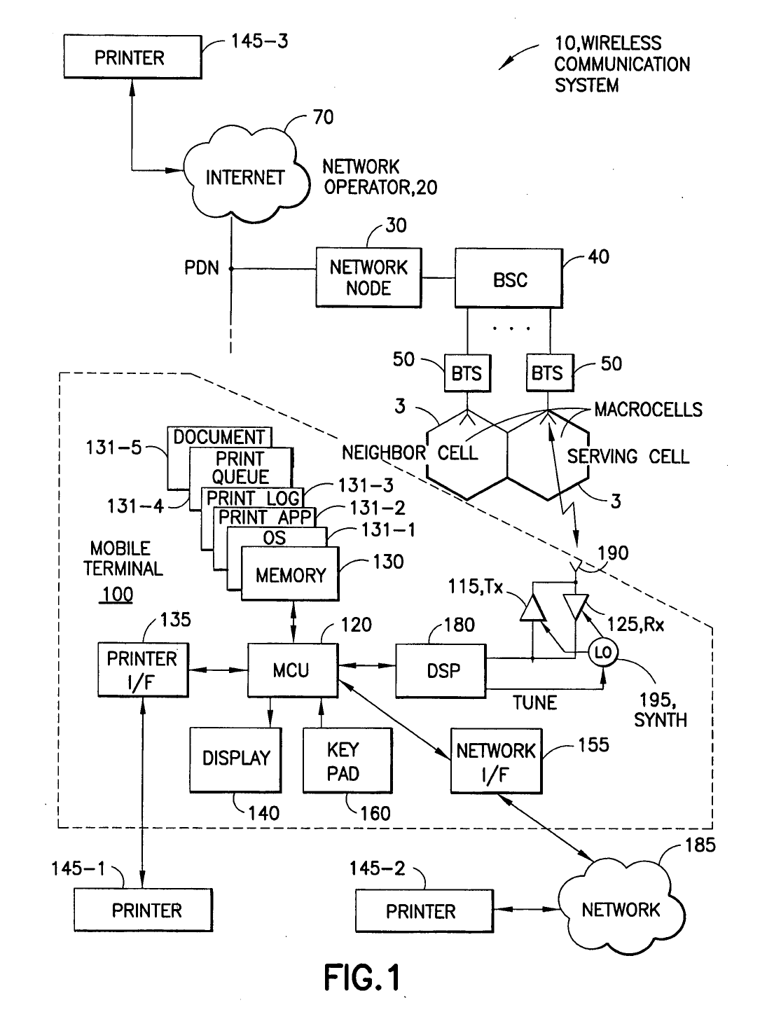

By way of introduction, and referring to FIG. 1, there is shown a simplified block diagram of an embodiment of a wireless communications system 10 that is suitable for practicing this invention. The wireless communications system 10 includes at least one mobile terminal (MT) 100. Also shown is an exemplary network operator 20 having, for example, a network node 30 for connecting to a telecommunications network, such as a Public Packet Data Network or PDN, at least one base station controller (BSC) 40 or equivalent apparatus, and a plurality of base transceiver stations (BTS) 50, also referred to as base stations (BSs), that transmit in a forward or downlink direction both physical and logical channels to the mobile terminal 100 in accordance with a predetermined air interface standard. A reverse or uplink communication path also exists from the mobile terminal 100 to the network operator, which conveys mobile originated access requests and traffic. A cell 3 is associated with each BTS 50, where one cell will at any given time be considered to be a serving cell, while an adjacent cell(s) will be considered to be a neighbor cell. Smaller cells (e.g., picocells) may also be available.

The air interface standard can conform to any suitable standard or protocol, and may enable both voice and data traffic, such as data traffic enabling Internet 70 access and web page downloads. In an exemplary embodiment of this invention, the air interface standard is compatible with a code division multiple access (CDMA) air interface standard, such as one known as cdma2000, although this is not a limitation upon the practice of this invention.

The mobile terminal 100 typically includes a microcontrol unit (MCU) 120 coupled to an input of a display 140, to a keypad (e.g., a keyboard) 160, to a printer interface (I/F) 135, and to a network interface 155. The mobile terminal 100 could also be contained within a card or module that is connected during use to another device. For example, the mobile terminal 10 could be contained within a Personal Computer Memory Card International Association (PCMCIA) or similar type of card or module that is installed during use within a portable data processor, such as a laptop or notebook computer, or even a computer that is wearable by the user.

In general, the various embodiments of the MT 100 can include, but are not limited to, cellular telephones, personal digital assistants (PDAs), portable computers, image capture devices such as digital cameras, gaining devices, music storage and playback appliances, Internet appliances permitting Internet access and browsing, as well as portable units that incorporate combinations of such functions.

The MCU 120 is assumed to include or be coupled to some type of a memory 130, including a non-volatile memory (e.g., read only memory, firmware, or the like) for storing an operating program and other information, as well as a volatile memory (e.g., random access memory, firmware that can be rewritten, and the like) for temporarily storing required data, scratchpad memory, received packet data, packet data to be transmitted, and the like. The memory 130 includes an operating system 131-1, a print application 131-2, a print log 131-3, a print queue 1314, and a document 131-5. The operating system 131-1, print application 131-2, print log 131-3, and print queue 131-4 in memory 130 are assumed, for the purposes of this invention, to enable the MCU 120 to execute the software routines, layers and protocols required to implement the methods in accordance with this invention, as well as to provide a suitable user interface (UI), via display 140 and keypad 160, with a user. Although not shown, a microphone and speaker are typically provided for enabling the user to conduct voice calls in a conventional manner.

The mobile terminal 100 also contains a wireless section that includes a digital signal processor (DSP) 180, or other high speed processor or logic, as well as a wireless transceiver that includes a transmitter 115 and a receiver 125, both of which are coupled to an antenna 190 for communication with the network operator. At least one local oscillator, such as a frequency synthesizer (SYNTH) 195, is provided for tuning the transceiver. Data, such as digitized voice and packet data, is transmitted and received through the antenna 190.

A user of mobile terminal 100 would like to be able to print document(s) 131-5 to a printer. Possible printers to be used include printer 145-1, directly coupled to the mobile terminal 100 through the printer interface 135, printer 145-2, coupled to the mobile terminal 100 through a wired or wireless network 185 and network interface 155, and printer 145-3, coupled to the mobile terminal 100 through the Internet 70, the network node 30, the BSC 40, and the BTS 50. Typically, such printers are identified with easily understood names.

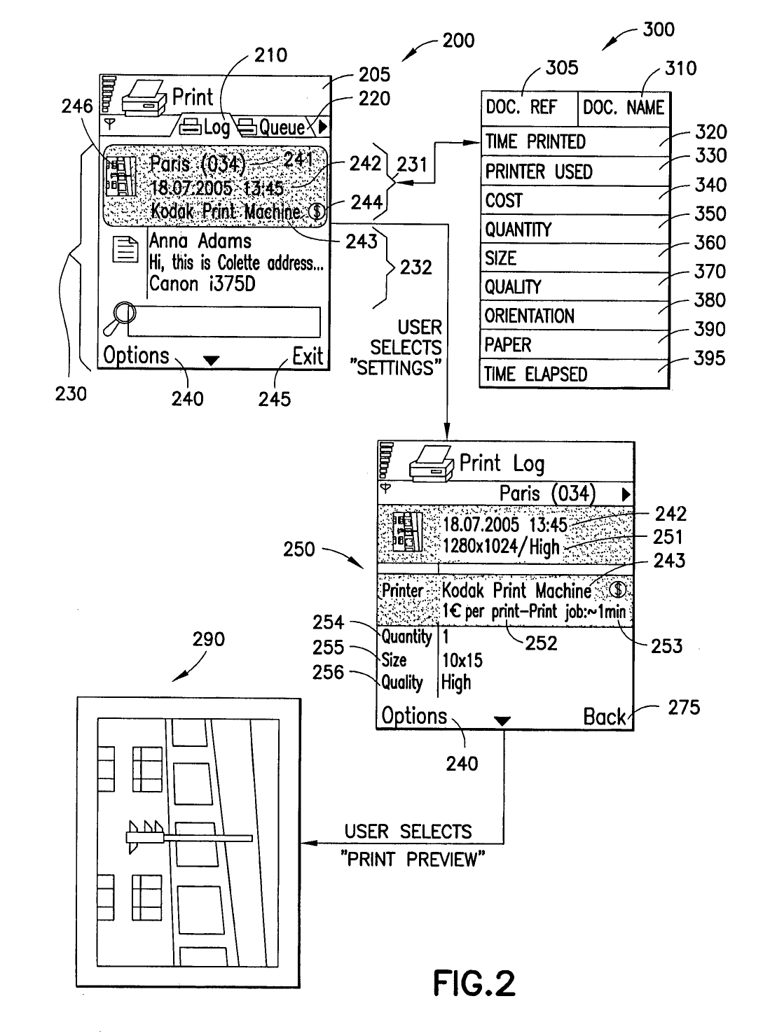

In this example, the print application 131-2 is an application that interacts with the operating system 131-1 to provide print capabilities on the mobile terminal 100. The print application 131-2 also can interact directly with other applications (such as WORD, EXCEL, image viewers, and the like) to enable these applications to print or to act as an application called by the operating system 131-1 when an application desires to print a document 131-5. In the examples to follow, the print application 131-2 controls the operation of the print log 131-3 and the print queue 131-4, and the print log 131-3 and print queue 1314 are simply storage devices. The operating system 131-1 is assumed to support multi-threading and multi-tasking. However, multi-threading and multi-tasking abilities are not necessary, but are beneficial. Consequently, FIGS. 2-6 are assumed to be performed by certain threads of the print application 131-2. In other embodiments, the print application 131-2, print log 131-3, and print queue 131-4 are each individual processes. In yet other embodiments, the printing application 131-2 (e.g., and possibly one or both of the print log 131-3 and print queue 131-4) is integrated into the operating system 131-1. As is known in the art, there are a number of different techniques for creating the methods, apparatus and signal bearing medium of the present disclosure, and any such techniques are considered to be part of the present disclosure.

The print queue 131-4 is used to hold print jobs that have not yet been printed. Once the print jobs are printed (e.g., as determined by a response by a printer or perhaps no error after data is communicated to the printer), the print jobs are transferred to the print log 131-3. It should be noted that each print job is associated with a document and it is the document that is printed. As described in additional detail below, each print job has a number of settings that define how the document is to be printed and on which printer(s). The disclosed invention concerns those settings that the user can control. Exemplary settings are described below. There are typically settings that are hidden from the user, such as the type of ‘language’ with which the printer communicates. While the disclosed invention is not directed to the hidden settings, such settings could be modified using the present techniques, if desired.

A user of mobile terminal 100 would like to be able to “print” document(s) 131-5 to a printer, even when the printer is not available. The print application 131-2 and the print queue 131-4 allow the user to create print jobs that can be printed at some time when a suitable printer is available. The user can be notified when a suitable printer is available. Additionally, the print application 131-2 and the print queue 131-4 can allow the user to delete, copy, or modify print jobs in the print queue 131-4. Furthermore, the print application 131-2 and the print log 131-3 allow the user to easily reprint (e.g., to the same printer or a different printer) print jobs, or use one or more settings from a selected print job from the print log 131-3 when printing a different document 131-5 than that currently associated with the selected print job.

Referring now to FIG. 2, a diagram is shown of screens showing a print preview operation performed by a user using print application 131-2. FIG. 2 shows three screen views 200, 250, and 290 (e.g., presented on display 140), as a user would see these when the user would like to preview a previously printed print job for possible reprinting (e.g., or for possible use to define settings used for a document 131-5 different than that associated with the print job). In this example, print screen 205 is created by the print application 131-2, when the user selects viewing of the print screen 205. The print screen 205 contains a tab 210 corresponding to the print log 131-3 and a tab 220 corresponding to the print queue 131-4. When the tab 210 is selected, a representation 230 of a portion of the print log 131-3 is shown. The representation 230 has view portions 231, 232, each of which corresponds to a print job in the print log 131-3.

The view portion 231 comprises a document name 241, a time printed 242, a printer name 243, a price icon 244, and a document icon 246. The view 231 is a representation of the data in print job 300 of the print log 131-3. Print job 300 comprises the settings of a document reference 305, a document name 310, a time printed 320, a printer used 330, a cost 340, a quantity 350, a size 360, a quality 370, an orientation 380, a paper 390, and a time elapsed 395. The settings 305-390 are print settings and are merely exemplary and there may be fewer, more, or different settings. The document reference 305 is a reference to where the document resides in memory 130. Such a reference could be a range of memory locations, a directory, etc. The document name setting 310 is typically a user-supplied name, but may also be a name given by the operating system 131-1 to the document. The document reference setting 305 (e.g., perhaps in combination with the document name 310) allows a single document 131-5 to be determined. The time printed setting 320 is the date and time printed. The printer used setting 330 is a name or other indicia indicating the printer used to print the document. The quantity setting 350 is the number of prints (e.g., which could be the total number of prints based on number of pages of the document 131-5 and number of copies, or just the number of copies). The size setting 360 is the size of the print. The quality setting 370 is typically a moniker such as “High” or “Low,” although a bit depth (such as 32 bits/pixel) and/or number of pixels could be used. The orientation setting 380 is an indication of how the document should be oriented on the selected paper. The paper setting 390 is a description of the type of paper to be used, if supported, such as “best quality” or “draft.” The time elapsed setting 395 indicates how long the printing took.

The document name 241 corresponds to the document 131-5, and is typically a representation of the data in document name setting 310 of the print job 300. The time printed 242 is a representation of the data in time printed setting 320. The printer name 243 is a representation of the data in time printed setting 320, and the price icon 244 indicates that the printing cost money (as indicated by the data in cost setting 340). The document icon 246 is an icon that is indicative of the document 131-5. In the case of image documents 131-5, the document icon 246 is a small version of the larger image. Note that the examples herein assume that the document icon 246 can be determined by the document reference setting 305 and/or the document name setting 310. However, a reference to an icon can be stored in print job 300, if desired. It should be noted that the user could exit anytime by using the exit menu 245.

Screen view 250 is shown by the print application 131-2 after the user selects the view portion 231, such as by using a “settings” option on the options menu 240. The user can return to the previous screen view 200 by using the back menu 275. The screen view 250 shows the quality 251 (e.g., as determined by the quality setting 370) is 1280×1024, called “high” quality, that it cost 252 (as indicated by the cost setting 340) “1ε” for the print, that the print time 253 (as indicated by the time elapsed setting 395) was one minute, that the quantity 254 (as indicated by the quantity setting 350) was one, the size 255 was 10×15 (as indicated by the size setting 350), and the quality 256 was “high” (as indicated by the quality setting 370).

After the user selects a “print preview” option on the options menu 240, the screen view 290 is shown. Screen view 290 is a view of how the document 131-5 printed.

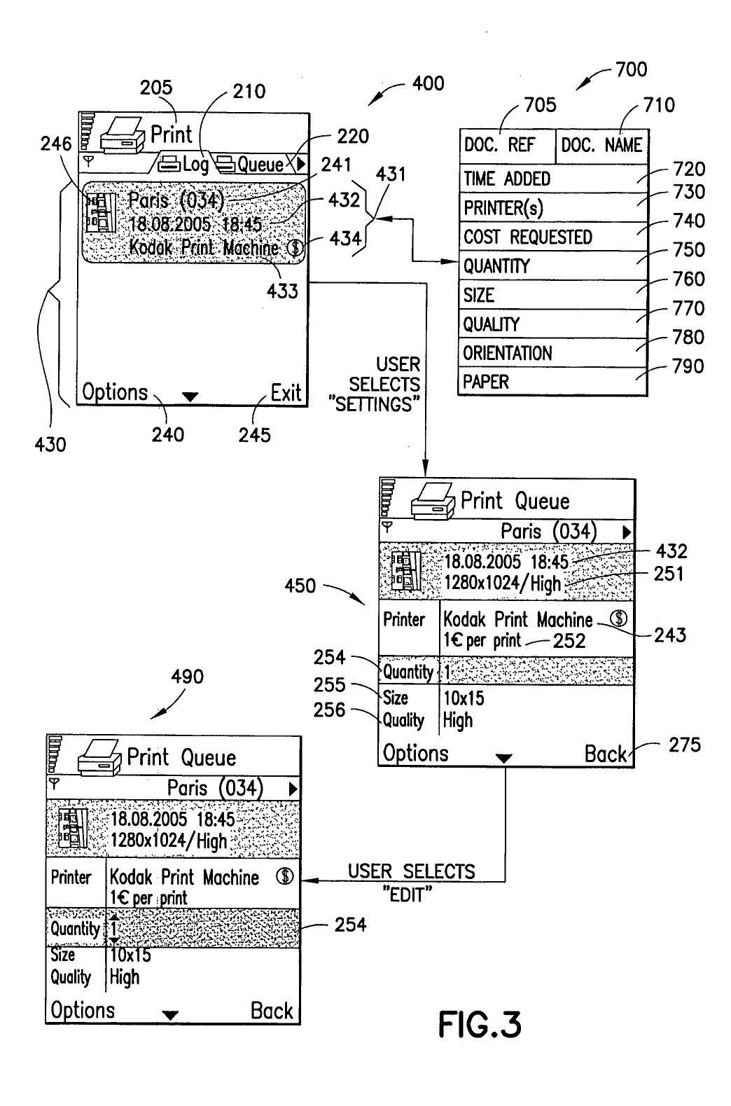

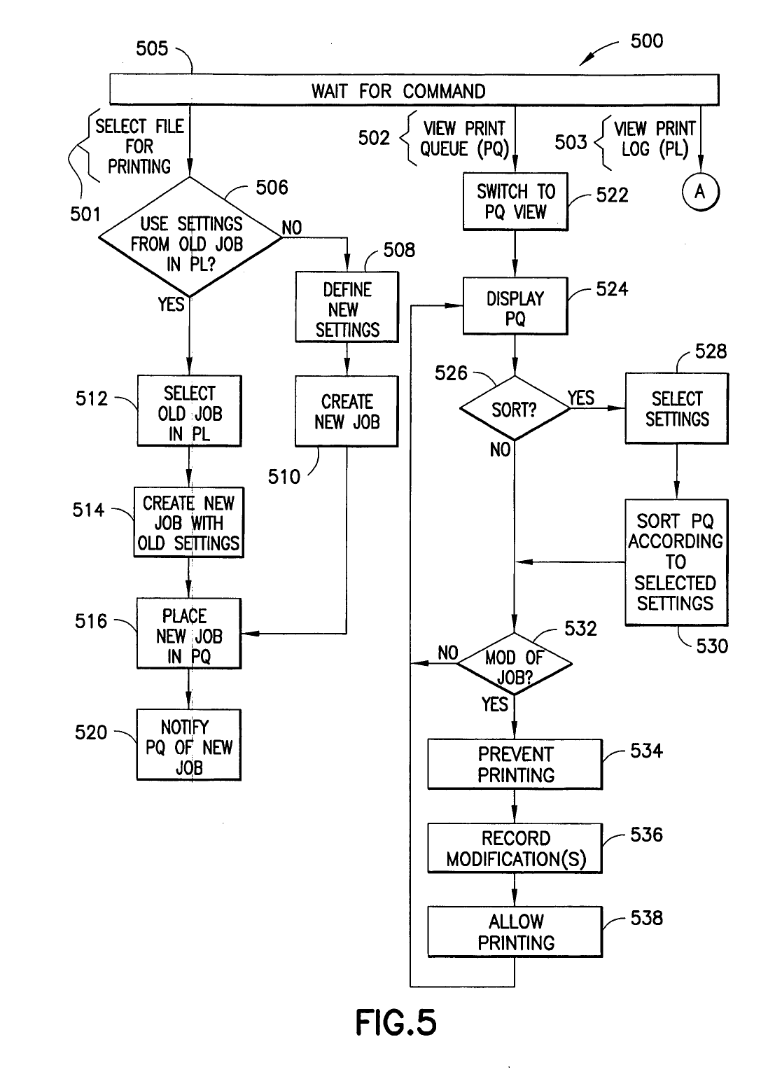

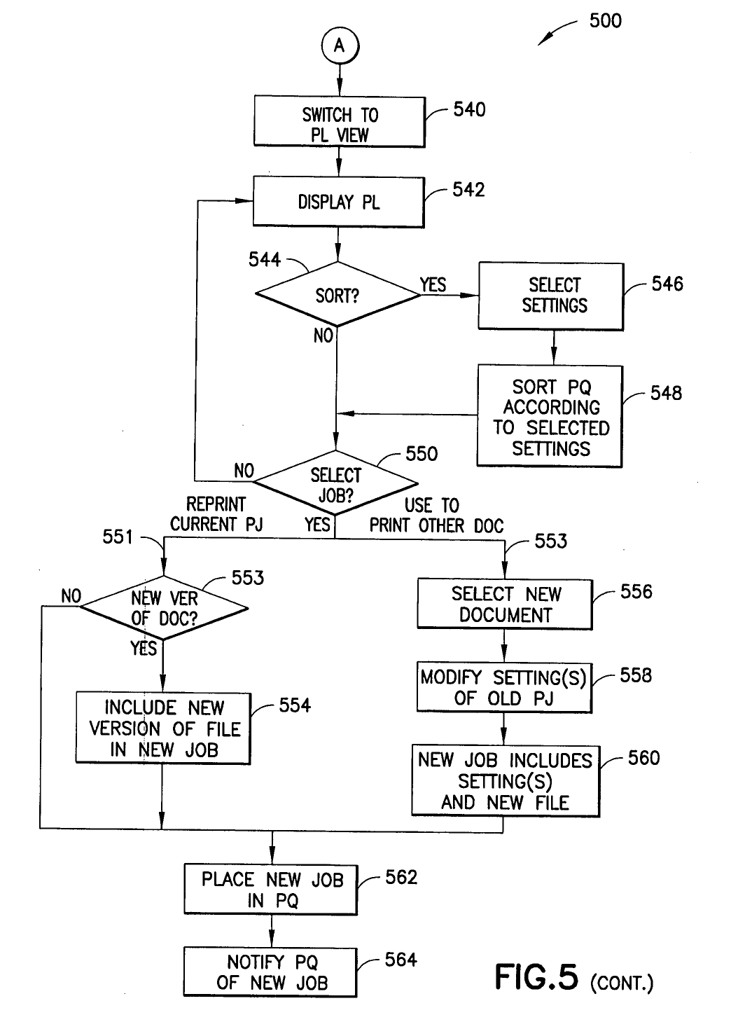

Turning now to FIG. 3, a diagram is shown of screens showing an operation of modifying settings for a print job, the modification performed by a user using print application 131-2. FIG. 3 shows three screen views 400, 450, and 490, as a user would see these when modifying settings for a print job in the print queue 131-4. The print job could be created, for instance, if the user selected (e.g., by using a “print” option in the options menu 240 of FIG. 2) the document 131-5 corresponding to “Paris (034)” to print. In the example of FIG. 3, the previously printed job shown in FIG. 2 in view portion 231 has been selected for reprinting. Consequently, some of the settings in print job 300 of the print log 131-3 are used to populate print job 700 of the print queue 131-4, as described in more detail below. This process allows very fast reprinting of a previously printed document, and also allows a new document to be associated with settings used for a previously printed document (the latter is described in more detail in reference to FIG. 5.).

In screen view 400, a representation 430 of the print queue 131-4 is shown. View portion 431 of representation 430 corresponds to print job 700 in the print queue 131-4. View portion 431 shows a time 432 at which the print job enters the print queue 131-4, a requested printer name 433, and a requested cost icon 434. The print job 700 comprises settings 705, 710, and 750-790, which correspond to settings 305, 310, and 350-390, respectively. Additionally, the settings of time added 720 (e.g., when the print job was added to the print queue 131-4), requested printer(s) 730 (e.g., printer(s) requested by the user, although the user could allow automatic selection of the printer(s)), and requested cost 740 (e.g., the requested cost for the print, which may exclude certain printers from use). The time 432 is a representation of time added setting 720, the requested printer name 433 is a representation of the data in the requested printer(s) setting 730, and the requested cost icon 434 indicates that the user has selected a cost ceiling (e.g., represented by the requested cost setting 740).

Screen view 450 is shown after the user selects the view portion 431, such as by choosing a “settings” option on the options menu 240. The screen view 450 also shows that the user has selected the quantity 254 (corresponding to the quantity setting 750 of the print job 700) on the screen. Screen view 490 shows a view as the user manipulates the quantity 254 (e.g., by selecting an “edit” option on the options menu 240). Any change to the quantity 254 will be appropriately recorded in the quantity setting 750 of the print job 700.

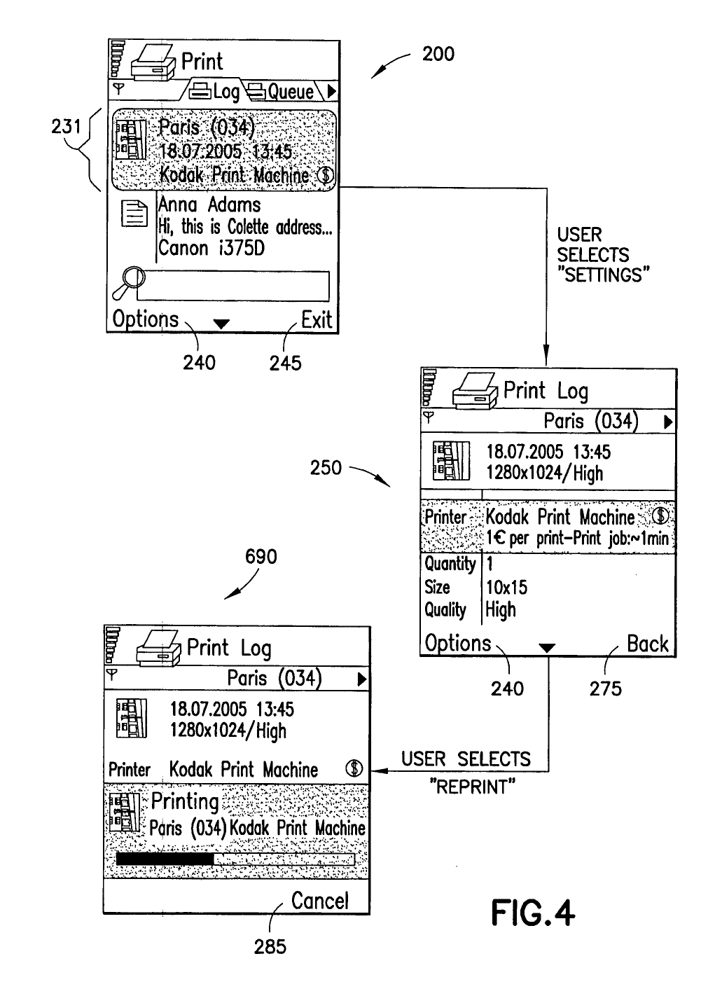

Referring now to FIG. 4, a diagram is shown of a reprinting operation performed by a user using a print application. In this example, the user performed the operations as discussed in reference to screen views 200 and 250 of FIG. 2. However, the user then decided to print the print job corresponding to the view portion 231 (e.g., by selecting a “reprint” option from the options menu 240). In this example, the printer is currently available, and the print job begins to print, as shown in view portion 690. It should be noted that in the case of the printer being available when the user decides to print a print job, the print job could be printed then sent to the print log 131-3 or sent to the print queue 131-4, printed, and sent to the print log 131-3. The cancel menu 285 can be used to cancel printing.

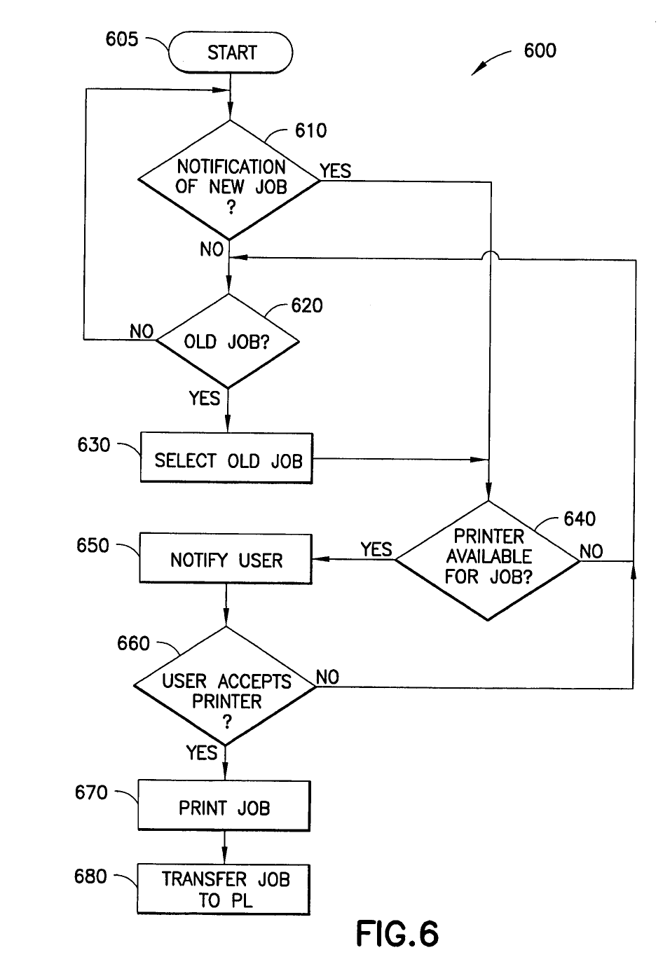

FIG. 5 is a flowchart of an exemplary method 500 performed by a print application. Both FIGS. 5 and 6 are performed, in an exemplary embodiment, by the print application 131-2. The method shown in FIG. 5 is directed to a user printing from an application, and the operation of the print application 131-2 with respect to displaying (as shown in FIGS. 2-4) the print queue 131-4 and the print log 131-3. The method shown in FIG. 6 is directed to how the print application 131-2 works with the print queue 131-4 in order to print the print jobs in the print queue 131-4. The method shown in FIG. 6 is expected to be executed by a thread independent of and separate from a thread executing the method shown in FIG. 5. However, these threads and methods could be combined. Additionally, more threads or objects could be created. For instance, operation (e.g., and display) of the print log 131-3 could be a separate thread or object, as could operation (e.g., and display) of the print queue 131-4.

Method 500 begins in step 505, when the print application 131-2 waits for a command. In the example of FIG. 5, there are three possible commands 501 (select file for printing), 502 (view print queue), and 503 (view print log). Command 501 is typically created when a user interacts with an application, such as WORD or an image viewer. Commands 502 and 503 are typically created when a user selects one of the tabs 210, 220, respectively. Other commands, such as commands input using, e.g., the options menu 240, the exit menu 245, the back menu 275, and cancel menu 285 are not shown. In the example of FIG. 5, the commands 501, 502, and 503 are assumed to be mutually exclusive (e.g., command 502 is not received while command 501 is received). However, this is not necessary.

When a user prints from an application, the command 501 is created. Such a command 501 could be created by, for instance, selecting “print” from a menu in an application, such as WORD, EXCEL, or a program used to view images. In step 506, the print application 131-2 queries the user as to whether the user would like to apply one or more settings from a print job 300 in the print queue 131-4 to the current document. If so (step 506=YES), the print application 131-2 asks the user to select a print job 300 from the print log 131-3 (step 512). It should be noted that the user may also be provided with an opportunity to sort the print log 131-3 in step 512. Once the user selects a print job (step 512), a new print job is created (step 514) using the settings from the print job 300 in the print log 131-3. Note also that the user will typically be given the opportunity to cancel this operation, although such cancellation is not shown in FIG. 5. Note that generally most settings (e.g., 305, 310, and 350-390) from a print job 300 in the print log 131-3 will be copied into a new print job. Settings (e.g., 320, 340, and 395) that are unique to the print log 131-3 will generally not be copied to the print queue 131-4. As for the printer used setting 330, this also may be copied as the requested printer 730 setting. However, the user may be given the option to select some and not all of the settings or perhaps to change the settings once the new print job is created. In step 516, the new print job is placed in the print queue 131-4, as one of the print jobs 700.

If the user decides to create a new print job using all new settings (step 506 NO), the user can define new settings (step 508). A new print job will be created using these new settings (step 510), and will be placed into the print queue 131-4 as a print job 700. In step 520, the print queue 131-4 (e.g., a thread that controls certain actions performed by the print queue 131-4, as described in reference to FIG. 6) is notified of a new print job 700.

If a command 502 of viewing the print queue 131-4, as created for instance by selecting tab 220 shown in FIGS. 2-4, is determined to occur by the print application 131-2, then the print queue 131-4 view is switched to (step 522) a print queue 131-4 view and a representation (e.g., representation 430 of FIG. 3) of some or all of the contents of the print queue 131-4 is displayed by the print application 131-2 (step 524). In step 526, the user is provided the option of sorting the print queue 131-4 using one or more settings (e.g., settings 705-790 of a print job 700 of the print queue 131-4). The user selects the settings in step 528, and the print application 131-2 will sort the print queue 131-4 by the settings and display a representation of the sorted print queue 131-4 (e.g., or a portion thereof). For instance, the print queue 131-4 could be sorted by date/time, size, quality, cost, etc. The user can also manually sort (e.g., arrange) the print jobs 700 in the print queue 131-4.

The user can also select and request to modify a print job 700 in the print queue 131-4. This occurs in step 532. If there is no request for modification (step 532=NO), the method 500 continues in step 524. Note that the user would typically be provided the option to sort (step 526) the print queue 131-4 only once. If the user decides to modify a print job 700 (step 532=YES), the print application 131-2 prevents printing of the print job 700 (step 534), and then allows the user to modify the settings 705-790 (it should be noted that 720 is typically not modifiable) in step 536. Once the user is done modifying the settings, the print application 131-2 then allows printing in step 538. It should be noted that steps 534 and 538 prevent an independent thread (i.e., as described in reference to FIG. 6) from printing the document using the print job 700 while the user is modifying the settings of the print job 700. If the thread that performs method 600 of FIG. 6 is not separate from the thread that performs method 500 of FIG. 5, then steps 534 and 538 would typically not be needed.

When a user selects to view the print log 131-3, such as by selecting tab 210, command 503 is created. In response, the print application 131-2 switches to the print log 131-3 view (step 540) and displays a representation (e.g., representation 230 of FIG. 2) of some or all of the print log 131-3 (step 542). The print application 131-2 allows the user to sort the print log 131-3 in step 544. If the user chooses to sort the print log 131-3 (step 544=YES), the user is allowed to select settings (e.g., settings 305-395 of a print job 300). Additionally, other settings, such as “show most popular documents” (e.g., sorted in terms of number of times a document has been printed), may be used. In step 548, the print log 131-3 is sorted according to the selected settings and a representation of the sorted print log 131-3 is displayed. The user may also manually sort (e.g., arrange) the print log 131-3. If the user chooses not to sort the print log 131-3 (step 550=NO), the method 500 continues in step 550.

In step 550, the user is given the option of selecting a print job 300 in the print log 131-3. If the user does not select a print job 300, the method continues in step 542. Note that the user would typically be provided the option to sort (step 544) the print log 131-3 only once. If the user selects a print job 300, there are generally two reasons for the user selecting the print job 300. The first reason is to reprint the document again (path 551). The second reason is to print another document, but to apply settings from the selected print job 300 to the new document (path 552).

Concerning path 551, the print application 131-2 determines if a new version of the document exists (step 553). If a new version of the document exists (step 553=YES), the new version of the file is included in the new print job (step 554). Versioning schemes are well known in the art. In fact, certain operating systems (e.g., operating system 131-1) support versioning. The new version of the file can be included, for instance, by providing an updated document reference 305 that references the new document. Method 500 continues in step 562. Note also that step 562 is performed when there is no new version of a document (step 553=NO).

Concerning path 552, the user may be viewing a representation of the print log 131-3 and may decide to use the settings of a print job 300 in the print log 131-3 for a new print job. For instance, the user may see that an image document has been printed with settings for pictures taken from a particular camera and for a particular printer at a print kiosk. When the user is near the print kiosk again, the user may decide to print other image documents from the camera on the printer at the kiosk. The user can select a print job 300 from the print log 131-3 and apply those settings to a different image document the user selects.

Thus, in step 556, the user selects a new document, which is to be printed with the settings from the currently selected print job 300. The user is provided an opportunity to modify the settings of the currently selected print job 300 (step 558). A new print job is created having a reference to the new file and the (potentially modified) settings from the print job 300 (step 560).

In step 562, the new print job is placed in the print queue 131-4 as a print job 700. In step 564, the print queue 131-4 is notified of the new print job 700.

FIG. 6 is a flowchart of an exemplary method 600 performed by a print application for certain operations of a print queue. Method 600 starts in step 605, typically when a thread is created that executes the method steps of method 600. In the example, of FIG. 6, the thread is part of the print application 131-2, although multi-threading is not necessary. Additionally, method 600 could be performed by software (e.g., an object) separate from the print application 131-2.

In step 610, the thread of the print application 131-2 determines if there is a notification of a new print job 700. If not (step 610=NO), the thread determines if there is an old job pending (step 620). If not (step 620=NO), the method 600 continues in step 610. If there are old jobs pending (step 620=YES), the thread selects an old job (step 630). The method 600 continues in step 640. Step 640 is also reached in response to a notification of a new job (step 610=YES).

In step 640, it is determined if a suitable printer is available for a print job 700. Typically, a user will select specific printer(s) for the print job 700. If this is the case, step 640 will ensure that one of the specified printer(s) is found to be available. For instance, the printer could be determined as being available when the user comes within range of a WLAN, and one of the specified printer(s) is found on the WLAN. Similarly, if the user connects to a wired or wireless network at home, a home printer could be found to be available. The user may also select that any suitable printer can be used to print the print job 700. In this case, any printer that is available and able to print using the print settings will be used to print the print job 700.

If a suitable printer is not available (step 640=NO), the method 600 continues in step 620. On the other hand, if a suitable printer is available (step 640=YES), the user is notified in step 650 of an available and suitable printer. The user is given the option of accepting or refusing the printer (step 660). If the user refuses the printer (step 660=NO), the method continues in step 620. In the user accepts the printer (step 660=YES), the method 600 continues in step 670. Note that steps 650 and 660 may be skipped, if desired, when a new print job 700 is added to the print queue 131-4.

In step 670, the print job 700 is printed on the available and suitable printer. In response to completion of the print job 700, the print job is transferred to the print log 131-3, as a print job 300. It should be noted that during the transfer, operations may be performed to change settings or to create new settings so as to convert the print job 700 to the print job 300. For instance, the time added setting 720 may be changed to the time printed setting 320. The time elapsed setting 395 may be added.

The embodiments of this invention may be implemented by computer software executable by a data processor of the mobile terminal 100, such as the MCU 120, or by hardware circuitry, or by a combination of software and hardware circuitry. Further in this regard it should be noted that the various blocks of the logic flow diagram of FIGS. 5 and 6 may represent program steps, or interconnected logic circuits, blocks and functions, or a combination of program steps and interconnected logic circuits, blocks and functions for performing the specified tasks. The embodiments of the present disclosure may also be implemented as a signal bearing medium tangibly embodying a program of machine-readable instructions executable by circuitry to perform operations disclosed herein.

It should be noted that the print queue 131-4 and print log 131-3 may be displayed together if desired. For instance, print jobs that have been printed (e.g., stored in the print log 131-3) and print jobs that are to be printed (e.g., stored in the print queue 131-4) could be shown on the same screen and differentiated by color or through other techniques. Even though all print jobs are shown at the same time, there are still a print queue 131-4 and a print log 131-3.

Another example of how a user can interact with the print log 131-3 is as follows. When a print job 500 is printed, the print application 131-2 causes the printer to print out a link (e.g., an identifier) on some portion of the photograph. The portion will likely be on the back of the photograph but may be in any region of the photograph that can be read by a machine. The link is in a form that is machine readable and may be any item suitable for identifying a particular print job 300 of the print log 131-3. For instance, the link could include the file name, date printed, printer used, and the like. When the user happens to have the original or a copy of the print from the print job 300 on hand, and wants to access quickly the print settings for that print job 300, the user uses the camera on his mobile terminal 100 to take a picture of at least the portion of the print containing the link. It should also be noted that a separate camera could be used and the picture loaded into the mobile terminal 100 for analysis. The picture is analyzed (e.g., by the print application 131-2) to determine link information corresponding to the link, and the print log 131-3 is accessed to retrieve the correct print log entry (e.g., a print job 300). In one exemplary embodiment, the link information is a digital version (e.g., ASCII characters) of the link. In another exemplary embodiment, the link information is a data structure comprising information from the link. The link information is any information suitable for use to determine a corresponding print job 300. The access may entail a search for a print job 300 that corresponds to the link. Settings from the print job 300 are then used for a new print job 500. This process of determining print settings from a print of a previously printed print job is useful when the print log 131-3 for the user contains a large number of entries.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention. For instance, although mobile terminals have been discussed herein, the present techniques could apply to any apparatus from which a user can print. Another option would be to create a “batch” print job that uses settings from one print job to print a plurality of documents. In this way, an entire set of image documents could be printed using one set of settings from a print job. Although users have been describes as performing actions such as selection of print jobs and sorting the print queue 1314 or print log 131-3, scripts or other automatic programming tools could be used for such actions.

Furthermore, some of the features of the embodiments of this invention could be used to advantage without the corresponding use of other features. As such, the foregoing description should be considered as merely illustrative of the principles of the present invention, and not in limitation thereof.

What is claimed is:

1. A method comprising:
providing a print log adapted to store first print jobs that have been used for printing, each of the first print jobs comprising a plurality of first settings;
providing a print queue adapted to store second print jobs that have not been used for printing, each of the second print jobs comprising a plurality of second settings;
using first settings from a selected first print job as corresponding second settings for a new second print job; and
placing the new second print job in the print queue to be used for printing in response to a printer corresponding to the new print job being available.

2. The method of claim 1, further comprising:
analyzing data from a picture of a portion of a print of a first print job, wherein the portion comprises a link corresponding to the first print job, and wherein the analysis determines link information corresponding to the link; and
using the link information to select the corresponding first print job in the print log, the selected first print job used when using first settings as corresponding settings for the second print job.

3. The method of claim 1, further comprising:
adding print jobs that have not been used for printing to the print queue; and
transferring print jobs that have been used for printing from the print queue to the print log.

4. The method of claim 3, wherein transferring further comprises:
a given second print job is transferred from the print queue to the print log as a given first print job;
in response to the transfer, changing any second settings in the given second print job to corresponding first settings in the given first print job and adding any first settings that need to be added to the given second print job.

5. The method of claim 4, wherein changing comprises changing a time added to the print queue setting of the given second print job to a time printed setting of the given first print job.

6. The method of claim 4, wherein adding comprises adding a time elapsed setting to the given first print job.

7. The method of claim 1, wherein:
the printer corresponding to the new second print job is available when the new second print job is placed into the print queue; and
the method further comprises printing a document corresponding to the new second print job by using the second settings in the new second print job and the printer corresponding to the new second print job.

8. The method of claim 1, wherein:
the printer corresponding to the new second print job is not available when the new print job is placed into the print queue; and
the method further comprises waiting for the printer corresponding to the new second print job to be available, and printing, in response to the printer corresponding to the new second print job becoming available, a document corresponding to the new second print job by using the second settings in the new second print job and the printer corresponding to the new second print job.

9. The method of claim 1, wherein using further comprises using a single first setting from the selected first print job as a corresponding single second setting for the new second print job, and wherein the single first setting is the only setting used from the selected first print job.

10. The method of claim 1, wherein using further comprises using at least two first settings from the selected first print job in the print log as corresponding second settings for the new second print job.

11. The method of claim 1, further comprising the step of printing a document corresponding to the new second print job when the printer corresponding to the print job is available, the step of printing using the second settings in the new second print job.

12. The method of claim 11, wherein the printer is determined to be available when the printer meets at least one of the following: the printer is one of a set of defined printers defined and the printer can be communicated with; and the printer meets a predetermined number of settings in the new second print job.

13. The method of claim 1, wherein:
a first document is associated with the selected print job through at least one first setting;
a second document is associated with the new print job through at least one second setting; and
the second document will be printed using the new second print job when a printer corresponding to the new second print job is available.

14. The method of claim 13, further comprising:
selecting the selected first print job;
selecting the second document; and
using is performed responsive to selecting the selected first print job.

15. The method of claim 1, further comprising allowing modification of certain second settings of a second print job in the print queue.

16. The method of claim 1, further comprising displaying representations of one or both of the print log and the print queue.

17. The method of claim 16, further comprising:
allowing selection of one of the print log and the print queue as a selected set of print jobs;
sorting the selected set of print jobs using at least one provided criterion; and
displaying a representation of the sorted selected set of print jobs.

18. The method of claim 17, wherein the at least one provided criterion comprises one or more of first settings for the print log, second settings for the print queue, a most printed criterion, and a provided arrangement.

19. The method of claim 1, wherein a predetermined number of settings in the new second print job are selected, and wherein the method further comprises using the predetermined number of settings to print a plurality of documents to the printer corresponding to the new second print job.

20. An apparatus comprising:
a print log adapted to store first print jobs that have been used for printing, each of the first print jobs comprising a plurality of first settings;
a print queue adapted to store second print jobs that have not been used for printing, each of the second print jobs comprising a plurality of second settings; and
a print application that uses first settings from a selected first print job as corresponding second settings for a new second print job and that places the new second print job in the print queue to be used for printing in response to a printer corresponding to the new print job being available.

21. The apparatus of claim 20, wherein the apparatus comprises a mobile terminal.

22. The apparatus of claim 20, wherein:
a first document is associated with the selected first print job through at least one first setting;
a second document is associated with the new second print job through at least one second setting; and
the second document will be printed using the new second print job when a printer corresponding to the new second print job is available.

23. The apparatus of claim 20, wherein the print application is further adapted to allow selection of the selected first print job and to allow selection of the second document, and the print application uses first settings from a selected first print job as corresponding second settings for a new second print job in response to selection of the first print job.

24. The apparatus of claim 20, wherein the print application is further adapted to analyze data from a picture of a portion of a print of a first print job, wherein the portion comprises a link corresponding to the first print job, and wherein the analysis determines link information corresponding to the link, and wherein the print application is further adapted to use the link information to select the corresponding first print job in the print log.

25. A signal bearing medium tangibly embodying a program of machine-readable instructions executable by circuitry to perform operations comprising:
providing a print log adapted to store first print jobs that have been used for printing, each of the first print jobs comprising a plurality of first settings;
providing a print queue adapted to store second print jobs that have not been used for printing, each of the second print jobs comprising a plurality of second settings;
using first settings from a selected first print job as corresponding second settings for a new second print job; and
placing the new second print job in the print queue to be used for printing in response to a printer corresponding to the new print job being available.

26. The medium of claim 25, wherein:
a first document is associated with the selected first print job through at least one first setting;
a second document is associated with the new second print job through at least one second setting; and
the second document will be printed using the new second print job when a printer corresponding to the new second print job is available.

27. The medium of claim 26, further comprising:
selecting the selected first print job;
selecting the second document; and
using is performed responsive to selecting the selected first print job.

28. An apparatus comprising:
means for providing a print log adapted to store first print jobs that have been used for printing, each of the first print jobs comprising a plurality of first settings;
means for providing a print queue adapted to store second print jobs that have not been used for printing, each of the second print jobs comprising a plurality of second settings;
means for using first settings from a selected first print job as corresponding second settings for a new second print job; and
means for placing the new second print job in the print queue to be used for printing in response to a printer corresponding to the new print job being available.

29. The apparatus of claim 28, wherein:
a first document is associated with the selected first print job through at least one first setting;
a second document is associated with the new second print job through at least one second setting; and
the second document will be printed using the new second print job when a printer corresponding to the new second print job is available.

30. The apparatus of claim 29, further comprising:
means for allowing selection of the selected first print job;
means for allowing selection of the second document; and
the means for using is responsive to the means for allowing selection of the selected first print job.

31. A method comprising:
providing a print log adapted to store print jobs that have been used for printing;
providing a print queue adapted to store print jobs to be used for printing;
forming a new print job from a selected one of the print jobs in the print log;
placing the new print job in the print queue; and
printing using the new print job in response to a printer corresponding to the new print job being available.

32. The method of claim 31, wherein the selected print job has a first document associated therewith, forming a new print job further comprising associating a second document with the new print job, and printing prints the second document using settings in the new print job.

33. The method of claim 31, wherein using further comprises using at least two first settings from the selected print job in the print log as corresponding second settings for the new print job.
